(19) United States
(12) Patent Application Publication
(10) Pub. No.: US 2023/0091598 A1
(43) Pub. Date: Mar. 23, 2023

(54) Method For Producing Soy Sauce-Like Seasoning

(71) Applicant: AJINOMOTO CO. INC., Tokyo (JP)

(72) Inventor: Yuri Kawanishi, Kanagawa (JP)

(73) Assignee: AJINOMOTO CO., INC., Tokyo (JP)

(21) Appl. No.: 18/048,519

(22) Filed: Oct. 21, 2022

Related U.S. Application Data
(63) Continuation of application No. PCT/JP2021/016221, filed on Apr. 21, 2021.

(30) Foreign Application Priority Data
Apr. 21, 2020 (JP) 2020-075589

(51) Int. Cl. A23L 11/00; A23L 5/10; A23L 23/00; A23L 27/10

(52) U.S. Cl. CPC A23L 11/05; A23L 5/13; A23L 23/00; A23L 27/10; A23V 2002/00

(57) ABSTRACT

The present invention provides an efficient production method of a new soy sauce-like seasoning with enhanced umami by using pea, broad bean, or chickpea as a main starting material instead of soybean, which includes a step of making koji (koji-making step), the koji-making step including using one kind of bean or two or more kinds of beans selected from pea, broad bean, and chickpea as starting material(s), in the presence of a crudely-refined protein and/or an amino acid.

This application is a Continuation of, and claims priority under 35 U.S.C. § 120 to, International Application No. PCT/JP2021/016221, filed Apr. 21, 2021, and claims priority therethrough under 35 U.S.C. § 119 to Japanese Patent Application No. 2020-075589, filed Apr. 21, 2020, the entireties of which, as well as all citations cited herein, are incorporated by reference herein.

### BACKGROUND

### Technical Field

The present invention relates to an efficient production method of a new soy sauce-like seasoning with enhanced umami, by using pea, broad bean, or chickpea as a main starting material instead of soybean.

### Background Art

Soy sauce, which is a traditional Japanese fermented seasoning and essential for eating habits in Japan, is produced by fermenting and brewing koji made from soybean and wheat, and a salt (sodium chloride) solution as starting materials. However, both soybean and wheat are positioned as foods containing allergic substances, and patients with soybean or wheat allergy cannot consume soy sauce depending on the severity of their health problems.

Therefore, a soy sauce-like seasoning that is preferably produced without using a food containing allergens, has the taste and aroma of soy sauce, and can be an alternative to soy sauce has been demanded.

Under such background, attempts have been made to produce a soy sauce-like seasoning without using soybean or wheat. For example, methods for producing soy sauce-like seasonings by using pea, broad bean, or perilla as a starting material are known (Patent Literatures 1 to 3). However, these production methods have a disadvantage that the soy sauce-like seasoning is thin and has less umami compared to ordinary soy sauce made from soybean and wheat as starting materials.

Patent Literature 1 relates to a soy sauce-like seasoning made from pea as a main starting material, and requiring maturation for 3 months or longer to achieve sufficient umami.

### CITATION LIST

PTL 1: JP-B-5702014

PTL 2: JP-B-4395608

PTL 3: JP-B-5011564

### SUMMARY

As described above, conventionally-known soy sauce-like seasonings produced from starting materials other than soybean and wheat are not sufficient in umami and the like as compared with regular soy sauce, and even when a crudely-refined protein is added during soy sauce-like seasoning-preparing, in order to solve this problem, maturation for 3 months or longer is required to achieve sufficient umami.

It has been found that umami can be unexpectedly enhanced in a short period of time by using pea, broad bean, and chickpea, which are free of known food allergy problems, as the main starting materials instead of soybean and wheat, which are the starting materials of regular soy sauce, as well as by preparing koji by adding a crudely-refined protein and/or an amino acid to the main starting materials at the stage of koji-making, not at the stage of soy sauce-like seasoning-preparing as is done in the conventional production of soy sauce-like seasonings (PTL 1).

It has also been found that the umami component can be sufficiently produced in a short period of time and the sour taste can be adjusted, by appropriately controlling the temperature in the maturation step following soy sauce-like seasoning-preparing.

It is an aspect of the present invention to provide a method for producing a soy sauce-like seasoning, comprising a koji-making step comprising using one kind of bean or two or more kinds of beans selected from pea, broad bean, and chickpea (as starting materials), in the presence of a crudely-refined protein and/or an amino acid.

It is a further aspect of the present invention to provide the method as described above, wherein the beans are steamed, preferably steamed after mixing with 30 to 200 g of water per 100 g of the total weight of beans, more preferably steamed after mixing with 50 to 150 g of water per 100 g of the total weight of beans, in the koji-making step.

It is a further aspect of the present invention to provide the method as described above, wherein the crudely-refined protein is one kind of crudely-refined protein or a mixture of two or more kinds of crudely-refined proteins, each selected from a crudely-refined pea protein, a crudely-refined broad bean protein, a crudely-refined chickpea protein, and a crudely-refined soybean protein.

It is a further aspect of the present invention to provide the method as described above, wherein the beans (the aforementioned starting materials) and the crudely-refined protein are mixed preferably mixed at a ratio of 99.5:0.5 to 0.5:99.5 (weight ratio of beans:crudely-refined protein), more preferably at a ratio of 98:2 to 30:70 (same weight ratio as above), further preferably at a ratio of 90:10 to 50:50 (same weight ratio as above).

It is a further aspect of the present invention to provide the method as described above, wherein the amino acid is one amino acid or a mixture of two or more amino acids, each selected from glutamine, arginine, glycine, and alanine.

It is a further aspect of the present invention to provide the method as described above, wherein the beans and the amino acid are mixed, preferably the amino acid is mixed with the beans at a ratio of 3% to 15% (weight ratio of amino acid with respect to beans), more preferably the amino acid is mixed with the beans at a ratio of 5 to 10% (same weight ratio as above), in the koji-making step.

It is a further aspect of the present invention to provide the method as described above, further comprising a step of mixing the koji obtained by the aforementioned koji-making step with a salt solution to produce “moromi” (main fermenting mash), and maturing the moromi within a temperature range of 5 to 55° C. (soy sauce-like seasoning-preparing and maturation step).

It is a further aspect of the present invention to provide the method as described above, wherein a seed koji derived from rice is used as a seed koji in the koji-making step.

It is a further aspect of the present invention to provide the method as described above, wherein the moromi is matured for 2 weeks to 6 months, preferably one month to 3 months, in the soy sauce-like seasoning-preparing and maturation step.

It is a further aspect of the present invention to provide the method as described above, wherein the moromi is matured in a temperature range of 5 to 50° C., preferably in a temperature range of 10 to 45° C., more preferably in a temperature range of 10 to 35° C., in the soy sauce-like seasoning-preparing and maturation step.

According to the method as described herein, a soy sauce-like seasoning with umami and flavor superior to those of conventional soy sauce-like seasonings can be produced without using soybean and wheat as starting materials. Moreover, a soy sauce-like seasoning with a high content of glutamic acid and the like, which are umami components, can be produced in a shorter period of time, and the mellowness thereof can also be adjusted as appropriate.

### DETAILED DESCRIPTION OF THE EXEMPLARY EMBODIMENTS

Generally, soy sauce is produced by (1) a step of inoculating seed koji into starting materials to produce koji (koji-making step), (2) a step of mixing the obtained koji with a salt solution to obtain moromi, and fermenting and maturing the moromi with lactobacillus and yeast appropriately added thereto (soy sauce-preparing and maturation step), and (3) a step of compressing the moromi after the fermentation and maturation to squeeze out a soy sauce to obtain a raw soy sauce, pasteurizing the raw soy sauce by applying heat, and racking the soy sauce. These general brewing steps are widely known to those of ordinary skill in the art. In practicing the methods as described herein, the technical matters other than those characteristic of the method as described herein may be added or changed as appropriate in accordance with ordinary production methods of soy sauce, to the extent that they do not depart from the gist of the method as described herein.

The technical matters are described in detail as follows. Unless otherwise specified, any technical terms and scientific terms used herein have the same meanings as those generally understood by those of ordinary skill in this art.

### Koji-Making Step

The production method of the soy sauce-like seasoning characteristically includes ‘a step of producing a koji in the presence of a crudely-refined protein and/or an amino acid, that is, by using one kind of bean or two or more kinds of beans selected from pea, broad bean, and chickpea as starting materials together with a crudely-refined protein and/or an amino acid (koji-making step).

One of the technical characteristics that is different from conventional production methods for soy sauce-like seasonings is that a crudely-refined protein and/or an amino acid are/is added in the koji-making step, not in the soy sauce-like seasoning-preparing and maturation step, to produce a koji together with the starting material beans.

When the amount of umami components (total nitrogen amount, particularly the glutamic acid amount) in a soy sauce-like seasoning produced by using alternative starting materials other than soybean and wheat is insufficient, to compensate for this, protein components or amino acids may be externally added during the production step. When such external addition is performed, those of ordinary skill in the art will generally adopt a method of adding them during the soy sauce-like seasoning-preparing and maturation step (see Patent Literature 1). There are two possible reasons for this.

The first reason is that the size of the room where koji is made is the rate-determining factor in the entire production steps of soy sauce-like seasonings. The total amount of raw materials for soy sauce-like seasoning-preparing can be increased by adding the supplemental proteins or amino acids to koji taken out after koji production, which in turn contributes to increased production of soy sauce and soy sauce-like seasonings. Therefore, a method of adding supplemental proteins or amino acids in the koji-making step is generally avoided.

The second reason is that if supplemental proteins or amino acids are added in the koji-making step, in which Aspergillus oryzae proliferates and the production of protease and glutaminase necessary for subsequent fermentation is promoted, they are consumed as a protein source or an amino acid source for the growth of Aspergillus oryzae in the process of development. Therefore, they cannot be utilized as components in the soy sauce-like seasoning as the final product, and the effect of adding supplemental proteins or supplemental amino acids is diminished.

Contrary to the common technical knowledge of those of ordinary skill in the art, a crudely-refined protein and/or an amino acid are/is added in the koji-making step rather than in the soy sauce-like seasoning-preparing and maturation step, to produce a koji together with the starting material beans. This characteristic method cannot be easily accomplished by those of ordinary skill in the art. The superior effects achieved by the method as described herein are as described above, and the effects are described in more detail in the Example section below based on specific experimental results.

In the method as described herein, “pea”, “broad bean”, “chickpea”, “adzuki bean”, “lentil bean”, “mung bean”, “kidney bean”, “black-eyed pea” and/or “mottled kidney bean” are/is used instead of soybean and wheat, which are the starting materials of regular soy sauce and associated with food allergy problems. More preferably, “pea”, “broad bean” and/or “chickpea” are/is used. Particularly preferably, “pea” is used.

The “pea”, “broad bean” and/or “chickpea”, which are the beans used as the starting materials, are not particularly limited, and beans that are readily available in the market, whether domestic or foreign, can be purchased and used as appropriate.

One kind of bean alone, or a mixture of two or more kinds of beans, selected from “pea”, “broad bean”, and “chickpea” can be used as starting materials.

Beans are preferably steamed in advance for the purpose of facilitating the action of Aspergillus oryzae on the beans and for the purpose of sterilization.

The amount of water used for steaming can be appropriately determined by those of ordinary skill in the art. From the aspect of good growth of Aspergillus oryzae, it is preferable to steam the beans after mixing them with 30 to 200 g of water per 100 g of the total weight of the beans, and it is more preferable to steam the beans after mixing them with 50 to 150 g of water per 100 g of the total weight of the beans.

The method for steaming is not particularly limited and steaming can be performed by a method generally used in the pertinent technique field. The method can be appropriately selected by those of ordinary skill in the art according to the amount of beans used and the like.

As the “crudely-refined protein”, a protein component crudely refined and/or concentrated as a result of removing components other than proteins, such as carbohydrates, lipids, and the like, or a protein component extracted, and then crudely refined and/or concentrated can be used. A protein generally used in the pertinent technical field for producing soy sauce can be used, or a vegetable crudely-refined protein can be used. More preferably, a bean-derived crudely-refined protein can be used, and further preferably, an allergen-free crudely-refined protein can be used where necessary. Although not particularly limited, a protein derived from food is preferably used, a crudely-refined pea protein, a crudely-refined broad bean protein, a crudely-refined chickpea protein, or a crudely-refined soybean protein is more preferably used, and, for example, a commercially available protein can be purchased and used.

One kind of crudely-refined protein, or a mixture of two or more kinds thereof, can be used.

As the “amino acid” to be used, one generally used in the pertinent technical field for producing soy sauce can be used. Although not particularly limited, glutamine, arginine, glycine, or alanine is preferably used. More preferably, it is glutamine, glycine, or alanine, further preferably, glutamine, and, for example, a commercially available amino acid can be purchased and used.

One kind of amino acid alone, or a mixture of two or more kinds thereof can be used.

As used herein, the “allergen” refers to items that may cause allergic symptoms when ingested as food, and includes, for example, items that are designated as “specified raw materials, etc.” including allergic substances in the Food Labeling Act Food Labeling Standards. Such standards can be changed under international cooperation from the viewpoint of food hygiene. Those of ordinary skill in the art can appropriately determine allergic or non-allergic and practice the present invention.

Being “allergen-free” means that it is substantially free of allergens, and includes both a case where allergens are not contained at all and a case where only an amount of allergens that does not provoke an allergic reaction is contained.

The koji-making step is performed in the presence of a “crudely-refined protein” and/or an “amino acid”. More specifically, the “crudely-refined protein” and/or the “amino acid” are/is preferably used by adding to and mixing with “beans”, more preferably used by adding to and mixing with steamed “beans”.

Those of ordinary skill in the art can appropriately determine the mixing ratio of beans and crudely-refined protein according to the desired total nitrogen content and the like. For example, they are mixed at a ratio of 99.5:0.5 to 0.5:99.5 (weight ratio of beans as starting materials and crudely-refined protein), preferably at a ratio of 98:2-30:70 (the same weight ratio as above), further preferably at a ratio of 90:10-50:50 (the same weight ratio as above), to practice the present invention.

Those of ordinary skill in the art can appropriately determine the mixing ratio of beans and amino acid according to the desired total nitrogen content and the like. For example, an amino acid is added and mixed with the beans at a ratio of 3% to 15% (weight ratio of amino acid with respect to beans as starting material), preferably an amino acid is added and mixed with the beans at a ratio of 5 to 10% (same weight ratio as above).

The method for making koji is not particularly limited and may be a method generally used in the pertinent technical field. Those of ordinary skill in the art can appropriately select the method according to the amount of the beans to be used and the like.

The seed koji is not particularly limited, but a seed koji produced using starting materials can be used. For example, a rice-derived koji (rice koji) is a particular example.

The seed koji can be inoculated into starting materials by the method and timing generally used in koji-making steps. The seed koji is preferably inoculated into a mixture of steamed beans and a crudely-refined protein and/or an amino acid.

The seed koji can be inoculated in an amount of 0.005 to 1.0 wt %, preferably 0.01 to 0.5 wt %, with respect to the total weight of the mixture of beans and a crudely-refined protein.

The koji-making can be performed in a temperature range of, for example, 20 to 40° C., more preferably 25 to 37° C. For example, it can be performed in a humidity range of 60 to 100%, more preferably 80 to 100%. A preferable period of koji-making is, for example, 36 to 72 hr, more preferably 40 to 60 hr.

### Soy Sauce-Like Seasoning-Preparing and Maturation Step

The production method of the soy sauce-like seasoning can be characterized in that it can further include “a step of mixing the koji obtained in the koji-making step with a salt solution to obtain moromi, and fermenting and maturing the moromi within a temperature range of 5 to 50° C. (soy sauce-like seasoning-preparing and maturation step)”.

The production of the moromi in this step can be performed by a method generally performed in the pertinent technical field. For example, 20-25% (w/w) of a salt solution is added at a ratio of 50 to 250 ml with respect to the weight (100 g) of the koji obtained by the koji-making step (derived from beans and a crudely-refined protein and/or an amino acid) and stirred to give moromi.

Addition of lactobacillus and yeast to the moromi is not essential. The moromi is matured for a given period under the action of an enzyme group mainly composed of a koji-derived enzyme group (hereinafter sometimes to be abbreviated as “the maturation”).

The maturation period is not particularly limited. The maturation generally performed for a period of 2 weeks to 6 months, preferably 2 weeks to 3 months.

The maturation period can be only one month to provide a result wherein the total amount of the nitrogen component tends to be slightly lower than that of conventionally known soy sauce-like seasonings produced by adding a crudely-refined protein at the time of soy sauce-like seasoning-preparing, and that glutamic acid is particularly produced in an amount considerably exceeding that of conventionally known soy sauce-like seasonings.

Also, it was confirmed with a maturation period of only one month that when amino acid is added, the amount of glutamic acid and/or the ratio of glutamic acid amount with respect to the total nitrogen amount considerably exceed(s) those of soy sauce-like seasonings produced by adding amino acid during soy sauce-like seasoning-preparing.

While the temperature of maturation is not particularly limited, for example, the maturation can be performed within a temperature range of 5 to 50° C., preferably performed within a temperature range of 10 to 45° C., more preferably performed within a temperature range of 10 to 35° C. The maturation in the present invention enables sufficient and rapid production of glutamic acid, which is particularly important as an umami component. In addition, it was confirmed that when maturation is performed at a low temperature, the production of organic acid components can be suppressed to a lower level, and a mellow soy sauce-like seasoning can be produced; on the other hand, when maturation is performed at a high temperature, a soy sauce-like seasoning superior in sour taste can be produced.

Therefore, the taste of the soy sauce-like seasoning can be adjusted according to the preference of the consumers, by appropriately controlling the maturation period and maturation temperature. This point is also one of the superior characteristics of the method as described herein.

The final soy sauce-like seasoning can be obtained by performing various steps such as compression, pasteurization and the like according to general procedures, after “the maturation” above. The final soy sauce-like seasoning can also be produced by further adding yeast and lactobacillus after “the maturation” above, further performing fermentation and maturation according to a regular soy sauce brewing step, and then performing various steps such as compression, pasteurization and the like according to general procedures. Those of ordinary skill in the art can appropriately determine which is to be selected, according to the quality of the desired soy sauce-like seasoning.

### EXAMPLES

The present invention is explained in more detail in the following by referring to Examples, which are not to be construed as limiting the scope of the present invention in any manner. The reagents, apparatuses and materials used are commercially available unless otherwise specified, and those of ordinary skill in the art can appropriately use and/or prepare them.

### Example 1: Production and Evaluation of Soy Sauce-Like Seasoning Using Pea as Starting Material

Koji-Making

Water (333 g, Comparative Examples 1 (1) to (3), or 600 g, Examples 1(1) to (3)) was added to 500 g of peas (yellow peas produced in Canada and America) and mixed. The mixture was steamed in an autoclave at 109° C. for 20 min. The mixture was allowed to cool to 40° C. or below, 0.1 wt % of seed koji (“Yoi Tane Koji for soy sauce”; manufactured by Bio′c Co., Ltd.) was mixed with 360 g of steamed peas based on raw materials (Comparative Examples 1(1) to 1(3)), or 288 g of steamed peas based on raw materials and 72 g of crudely-refined pea protein (note 1) (Examples 1(1) to 1(3)). This was placed on a net in a stainless container and koji was made in a thermostatic and humidistatic apparatus (temperature 30° C., humidity 95%) for 3 days. Due care was taken 18 hr later and 24 hr later during koji-making to ensure the conditions were maintained.

Soy Sauce-Like Seasoning-Preparing and Maturation

43 g of 23% w/w salt solution was added to 32 g of the obtained koji (derived from Comparative Examples 1(1) to 1(3)) and 8 g of crudely-refined pea protein, and the mixture was stirred well to obtain moromi. In addition, the salt solution was added to the koji prepared in Examples 1(1) to 1(3) such that the starting material weight, the crudely-refined pea protein weight, and the ratio of the salt solution were the same, and the mixtures were stirred well to give moromi (Examples 1(1) to 1(3)).

Each of the six groups of moromi prepared above was adjusted such that (1) the water content of the starting material after water absorption, and (2) when protein was added before koji-making, the average water content of the starting material after water absorption and the protein, were each about 47%.

The moromi (moromi of 6 groups prepared above) was stored in a constant temperature equipment at 30° C. for one month. One month after soy sauce-like seasoning-preparing, moromi was placed on non-woven fabric, squeezed by hand, and heated in a hot water bath at 85° C. for 30 min. Furthermore, after leaving same for 3 days in a constant temperature equipment at 55° C., the moromi was filtered through a filter paper to give a pea-fermented soy sauce-like seasoning (those derived from the koji of Examples 1(1) to 1(3) are abbreviated as the soy sauce-like seasonings of Examples 1(1) to 1(3), respectively, and those derived from koji of Comparative Examples 1(1) to 1(3) are abbreviated as the soy sauce-like seasonings of Comparative Examples 1(1) to 1(3), respectively).

In addition, the moromi derived from the koji of Examples 1(1) to 1(3) were stored in a constant temperature equipment at 15° C. for 1 month, and pea fermented soy sauce-like seasonings were obtained in the same manner as above (those derived from the koji of Examples 1(1) to 1(3) are abbreviated as the soy sauce-like seasonings of Examples 1(4) to 1(6), respectively).

Note 1: The following three kinds of crudely-refined pea proteins were used.

(A) Nutralys F85F (manufactured by Roquette) (used in Example 1(1), Comparative Example 1(1))

(B) Pea Protein Isolate EPPI (manufactured by Cargill Japan) (used in Example 1(2), Comparative Example 1(2))

(C) Pisane C9 (manufactured by Cosucra) (used in Example 1(3), Comparative Example 1(3))

The compositions of the soy sauce-like seasonings produced as described above (Examples 1(1) to 1(3), Comparative Examples 1(1) to 1(3)) are shown in Table 1 below.

TABLE 1

| | test plot No. | | | | | |
|---|---|---|---|---|---|---|
| | Comp. | | Comp. | | Comp. | |
| | Ex. | Ex. | Ex. | Ex. | Ex. | Ex. |
| | 1(1) | 1(1) | 1(2) | 1(2) | 1(3) | 1(3) |
| pea protein kind | (A) | (A) | (B) | (B) | (C) | (C) |
| added during koji- | x | ∘ | x | ∘ | x | ∘ |
| making | | | | | | |
| added during soy | ∘ | x | ∘ | x | ∘ | x |
| sauce-like | | | | | | |
| seasoning-preparing | | | | | | |

The results of component analysis of the soy sauce-like seasonings produced as described above (soy sauce-like seasonings of Examples 1(1) to 1(6) and Comparative Examples 1(1) to 1(3)) are shown in Table 2 below. In the Table, TN indicates the total nitrogen content (% w/v).

For component analysis, the total nitrogen was analyzed by the Dumas combustion method, the salt content was analyzed by potentiometric titration method, glutamic acid was analyzed by the high-performance liquid chromatography/mass spectrometry method, organic acids were analyzed by high-performance liquid chromatography, and pH was analyzed by the glass electrode method.

TABLE 2

| | | | | pyro- | | |
|---|---|---|---|---|---|---|
| | | | glutamic | glutamic | total organic | |
| sample | TN | salt | acid | acid | acid amount | |
| name | (% w/v) | (% w/v) | (% w/v) | (% w/v) | (% w/v) | pH |
| Comp. | 2.82 | 17.9 | 1.16 | 0.28 | 0.85 | 5.17 |
| Ex. 1(1) | | | | | | |
| Ex. 1(1) | 2.18 | 16.2 | 1.53 | 0.18 | 1.83 | 4.89 |
| Comp. | 2.66 | 17.7 | 1.02 | 0.28 | 0.77 | 5.09 |
| Ex. 1(2) | | | | | | |
| Ex. 1(2) | 2.49 | 19.3 | 1.63 | 0.10 | 1.32 | 4.91 |
| Comp. | 2.87 | 18.6 | 1.07 | 0.31 | 0.74 | 5.12 |
| Ex. 1(3) | | | | | | |
| Ex. 1(3) | 2.37 | 16.9 | 1.74 | 0.13 | 1.52 | 4.92 |
| Ex. 1(4) | 1.90 | 15.7 | 1.41 | trace | 0.62 | 6.04 |
| Ex. 1(5) | 2.06 | 17.2 | 1.50 | trace | 0.52 | 5.90 |
| Ex. 1(6) | 2.20 | 16.0 | 1.66 | trace | 0.50 | 6.09 |

From the above evaluation results, it is understood that the soy sauce-like seasonings of Examples 1(1) to 1(3) of the present invention showed slightly lower contents of the total nitrogen, but considerably higher amounts of glutamic acid, which is particularly important as an umami component, as compared with the soy sauce-like seasonings of Comparative Examples 1(1) to 1(3) in which crudely-refined protein was added at the time of soy sauce-like seasoning-preparing. From the difference in the amount of pyroglutamic acid, it is also understood that glutamic acid is produced more efficiently by the described method. The above evaluation results have revealed that the method as described herein affords such excellent effects with respect to the components of the soy sauce-like seasoning produced.

Furthermore, in the soy sauce-like seasonings of Examples 1(4) to 1(6), the total organic acid content decreased as compared with the corresponding soy sauce-like seasonings of Examples 1(1) to 1(3). It was clarified that the sour taste can be suppressed and a soy sauce-like seasoning with a mellower texture can be produced by the method as described herein by maturing the moromi at a lower temperature side. This is a superior characteristic of the method that leads to the ability to adjust the taste of soy sauce-like seasonings according to preference of the consumers.

### Example 2: Production and Evaluation of Soy Sauce-Like Seasonings Using Pea, Broad Bean, or Chickpea as Starting Material

Starting Material

A soy sauce-like seasoning was prepared using the following beans as starting materials and crudely-refined protein.

(1) Beans

pea: US #1 YELLOW SPLIT PEAS

broad bean: Dehulled Zhangjiakou broad beans (half cracked) from Hebei, China

chickpea: Garbançao produced in Canada

(2) Crudely-Refined Protein

pea protein: Pea Protein Isolate EPPI/RADIPURE E8001G

Koji-Making

Water (333 g, Control Example 2(1), Comparative Example 2(1), or 600 g, Example 2(1)) was added to 500 g of peas and mixed. The mixture was steamed in an autoclave at 109° C. for 20 min. The mixture was allowed to cool to 40° C. or below, 0.1 wt % of seed koji (“Yoi Tane Koji for soy sauce”; manufactured by Bio′c Co., Ltd.) was mixed with 364 g of steamed peas based on raw materials (Control Example 2(1), Comparative Example 2(1)), or 291 g of steamed peas based on raw materials and 73 g of crudely-refined pea protein (Example 2(1)). This was placed on a net in a stainless container and koji was made in a thermostatic and humidistatic apparatus (temperature 30° C., humidity 95%) for 44 hr. Due care was taken 18 hr later and 24 hr later during koji-making to ensure the conditions were maintained

The koji-making operation was performed in the same manner except replacing the peas with broad beans and chickpeas (for broad beans, Control Example 2(2), Comparative Example 2(2), and Example 2(2); for chickpeas, Control Example 2(3), Comparative Example 2(3), Example 2(3)).

Soy Sauce-Like Seasoning-Preparing and Maturation

84 g of 23% w/w salt solution was added to 56 g of the obtained koji (derived from Comparative Examples 2(1) to 2(3)) and 14 g of crudely-refined pea protein, and the mixture was stirred well to obtain moromi. In addition, the salt solution was added to the koji prepared in Examples 2(1) to 2(3) such that the starting material weight, the crudely-refined pea protein weight, and the ratio of the salt solution were the same, and the mixtures were stirred well to give moromi (Examples 2(1) to 2(3)).

For Control Examples 2(1) to 2(3), 84 g of 23% w/w salt solution was added to 70 g of the obtained koji and stirred well to obtain moromi.

Each of the 9 groups of moromi prepared above was adjusted such that (1) the water content of the starting material after water absorption, and (2) when protein was added before koji-making, the average water content of the starting material after water absorption and the protein, were each about 47%. The moromi (moromi of 9 groups prepared above) was stored in a constant temperature equipment at 15° C. for one month (one month storage group). For the 6-month storage group, 0.1% by weight of yeast (′salt-tolerant yeast “Diaden yeast”’ (Zygosaccharomyces rouxii) manufactured by Higuchi Matsunosuke Shoten) was added after 1-month storage, and stored for additional 5 months in a constant temperature equipment at 30° C.

One month (one month storage group) or 6 months (6 month storage group) after soy sauce-like seasoning-preparing, the moromi was placed on non-woven fabric, squeezed by hand, and heated in a hot water bath at 85° C. for 30 min. Furthermore, after leaving the resulting moromi for 3 days in a constant temperature equipment at 55° C., the moromi was filtered through a filter paper to give pea-fermented soy sauce-like seasonings (those derived from the koji of Example 2(1) are abbreviated as the soy sauce-like seasonings of Example 2(1), and those derived from koji of Comparative Example 2(1) are abbreviated as the soy sauce-like seasoning of Comparative Example 2(1)), broad bean-fermented soy sauce-like seasonings (those derived from the koji of Example 2(2) are abbreviated as the soy sauce-like seasoning of Example 2(2), those derived from the koji of Comparative Example 2(2) are abbreviated as the soy sauce-like seasoning of Comparative Example 2(2), and those derived from the koji of Control Example 2(2) are abbreviated as the soy sauce-like seasoning of Control Example 2(2), respectively), and chickpea-fermented soy sauce-like seasonings (those derived from the koji of Example 2(3) are abbreviated as the soy sauce-like seasoning of Example 2(3), those derived from the koji of Comparative Example 2(3) are abbreviated as the soy sauce-like seasoning of Comparative Example 2(3), and those derived from the koji of Control Example 2(3) are abbreviated as the soy sauce-like seasoning of Control Example 2(3), respectively).

The outline of each soy sauce-like seasoning obtained above is shown below.

TABLE 3

| | test plot No. | | | | | |
|---|---|---|---|---|---|---|
| | Cont. | Comp. | | Cont. | Comp. | |
| | Ex. | Ex. | Ex. | Ex. | Ex. | Ex. |
| | 2(1) | 2(1) | 2(1) | 2(2) | 2(2) | 2(2) |
| beans | pea | | | broad bean | | |
| crudely-refined | x | ∘ | ∘ | x | ∘ | ∘ |
| protein | | | | | | |
| added during koji- | x | x | ∘ | x | x | ∘ |
| making | | | | | | |
| added during soy | x | ∘ | x | x | ∘ | x |
| sauce-like | | | | | | |
| seasoning-preparing | | | | | | |

| | test plot No. | | |
|---|---|---|---|
| | Cont. Ex. 2(3) | Comp. Ex. 2(3) | Ex. 2(3) |
| beans | chickpea | | |
| crudely-refined protein | x | ∘ | ∘ |
| added during koji-making | x | x | ∘ |
| added during soy sauce- | x | ∘ | x |
| like seasoning-preparing | | | |

The results of component analysis of the soy sauce-like seasonings produced as described above (soy sauce-like seasonings of Examples 2(1) to 2(3), Comparative Examples 2(1) to 2(3), Control Examples 2(1) to 2(3)) are shown in Table 4 (one month storage group) and Table 5 (6 month storage group) below. In the Tables, Glu indicates the amount of glutamic acid (% w/v), TN indicates the total nitrogen content (% w/v) and Glu/TN indicates the amount of glutamic acid (% w/v) per 1% of TN.

For component analysis, the total nitrogen was analyzed by the Dumas combustion method, and glutamic acid was analyzed by the high-performance liquid chromatography/mass spectrometry method.

TABLE 4

| | test plot No. | | | | | |
|---|---|---|---|---|---|---|
| | Cont. Ex. | Comp. Ex. | Ex. | Cont. Ex. | Comp. Ex. | Ex. |
| | 2(1) | 2(1) | 2(1) | 2(2) | 2(2) | 2(2) |
| Glu | 0.57 | 0.53 | 0.69 | 0.43 | 0.42 | 0.75 |
| Glu/TN | 0.57 | 0.55 | 0.68 | 0.43 | 0.43 | 0.75 |

| | test plot No. | | |
|---|---|---|---|
| | Cont. Ex. 2(3) | Comp. Ex. 2(3) | Ex. 2(3) |
| Glu | 0.38 | 0.48 | 0.67 |
| Glu/TN | 0.40 | 0.50 | 0.66 |

TABLE 5

| test | Cont. | Comp. | | Cont. | Comp. | |
|---|---|---|---|---|---|---|
| plot | Ex. | Ex. | Ex. | Ex. | Ex. | Ex. |
| No. | 2 (1) | 2 (1) | 2 (1) | 2 (2) | 2 (2) | 2 (2) |
| Glu | 0.88 | 1.26 | 1.36 | 0.93 | 1.33 | 1.54 |
| Glu/TN | 0.55 | 0.54 | 0.64 | 0.41 | 0.46 | 0.61 |

| test plot | Cont. | Comp. | |
|---|---|---|---|
| No. | Ex. 2 (3) | Ex. 2 (3) | Ex. 2 (3) |
| Glu | 0.50 | 1.01 | 0.90 |
| Glu/TN | 0.39 | 0.44 | 0.50 |

From the above evaluation results, it is understood that the soy sauce-like seasonings of Examples 2(1) to 2(2) as described herein showed considerably higher amounts of glutamic acid (Glu), which is particularly important as an umami component, as compared with the soy sauce-like seasonings of Control Examples 2(1) to 2(2) in which crudely-refined protein was not added, and the soy sauce-like seasonings of Comparative Examples 2(1) to 2(2) in which crudely-refined protein was added at the time of soy sauce-like seasoning-preparing.

In addition, it is understood that the amount of glutamic acid % w/v per 1% of TN (Glu/TN) is also considerably higher. This indicates that the production efficiency of glutamic acid is improved more in the described method, in which crudely-refined protein is added during koji-making, as compared with the case where crudely-refined protein is not added (Control Example) or the case where crudely-refined protein is added during soy sauce-like seasoning-preparing (Comparative Example).

Therefore, the above evaluation results have revealed that the method as described herein affords such excellent effects with respect to the components of the soy sauce-like seasoning produced, regardless of whether peas or broad beans are used as the starting material.

Furthermore, in the one-month storage group, it is understood that the soy sauce-like seasoning of Example 2(3) was superior in both the amount of glutamic acid (Glu) and the amount of glutamic acid % w/v per 1% of TN (Glu/TN), as compared with the soy sauce-like seasoning of Control Example 2(3) in which crudely-refined protein was not added, and the soy sauce-like seasoning of Comparative Example 2(3) in which crudely-refined protein was added at the time of soy sauce-like seasoning-preparing.

In the 6 month storage group, it is understood that the soy sauce-like seasoning of Example 2(3) showed a slightly lower amount of glutamic acid itself, but considerably higher amount (% w/v) of glutamic acid per 1% of TN, as compared with the soy sauce-like seasoning of Comparative Example 2(3) in which crudely-refined protein was added at the time of soy sauce-like seasoning-preparing. Therefore, it is understood that the production efficiency of glutamic acid is improved in the method as described herein in which crudely-refined protein is added during koji-making.

Therefore, even when chickpea is used as a starting material, it is clear from the above evaluation results that the present invention exhibits superior effects with respect to the components of the soy sauce-like seasoning produced.

### Example 3: Examination of Influence of Maturation Temperature

Starting Material

A soy sauce-like seasoning was prepared using the following beans as starting materials and crudely-refined protein.

(1) Beans

broad bean: China Qinghai broad beans (round grain) dehulled product

(2) Crude Refined Protein

pea protein: Pea Protein Isolate EPPI/RADIPURE E8001G

(Malted Rice-Making)

Water (333 g, Comparative Examples 3(1) to 3(4)), or 600 g, Examples 3(1) to 3(4)) was added to 500 g of broad bean and mixed. The mixture was steamed in an autoclave at 109° C. for 20 min. The mixture was allowed to cool to 40° C. or below, 0.1 wt % of seed koji (“Yoi Tane Koji for soy sauce”; manufactured by Bio′c Co., Ltd.) was mixed with 393 g of steamed broad bean based on raw materials (Comparative Examples 3(1) to 3(4)), or 314 g of steamed broad bean based on raw materials and 79 g of crudely-refined pea protein (Examples 3(1) to 3(4)). This was placed on a net in a stainless container and koji was made in a thermostatic and humidistatic apparatus (temperature 30° C., humidity 95%) for 44 hr. Due care was taken 18 hr later and 24 hr later during koji-making to ensure the conditions were maintained

Soy Sauce-Like Seasoning-Preparing and Maturation

98 g of 23% w/w salt solution was added to 56 g of the obtained koji (derived from Comparative Examples 3(1) to 3(4)) and 14 g of crudely-refined pea protein, and the mixture was stirred well to obtain moromi. In addition, the salt solution was added to the koji prepared in Examples 3(1) to 3(4) such that the starting material weight, the crudely-refined pea protein weight, and the ratio of the salt solution were the same, and the mixtures were stirred well to give moromi (Examples 3(1) to 3(4)).

The moromi charged above was stored in a constant-temperature equipment under each of the following conditions: (i) 10° C. for one month (Comparative Example 3(1), Example 3(1)), (ii) 15° C. for one month (Comparative Example 3(2), Example 3(2)), (iii) 30° C. for one month (Comparative Example 3(3), Example 3(3)), or (iv) 35° C. for one month (Comparative Example 3(4), Example 3(4)). One month after soy sauce-like seasoning-preparing, moromi was placed on non-woven fabric, squeezed by hand, and heated in a hot water bath at 85° C. for 30 min. Furthermore, after leaving the moromi for 3 days in a constant temperature equipment at 55° C., the moromi was filtered through a filter paper to give a broad bean-fermented soy sauce-like seasoning (those derived from the koji of Examples 3(1) to 3(4) are abbreviated as the soy sauce-like seasonings of Examples 3(1) to 3(4), respectively, and those derived from koji of Comparative Examples 3(1) to 3(4) are abbreviated as the soy sauce-like seasonings of Comparative Examples 3(1) to 3(4), respectively).

Each of the 8 groups of moromi prepared above was adjusted such that (1) the water content of the starting material after water absorption, and (2) when protein was added before koji-making, the average water content of the starting material after water absorption and the protein, were each about 47%.

The outline of each soy sauce-like seasoning obtained above is shown below.

TABLE 6

| | test plot No. | | | |
|---|---|---|---|---|
| | Comp. Ex. | Ex. | Comp. Ex. | Ex. |
| | 3(1) | 3(1) | 3(2) | 3(2) |
| maturation temperature | 10 ° C. | | 15° C. | |
| added during koji-making | x | ∘ | x | ∘ |
| added during soy sauce- | ∘ | x | ∘ | x |
| like seasoning-preparing | | | | |
| | test plot No. | | | |
| | Comp. Ex. | Ex. | Comp. Ex. | Ex. |
| | 3(3) | 3(3) | 3(4) | 3(4) |
| maturation temperature | 30° C. | | 35° C. | |
| added during koji-making | x | ∘ | x | ∘ |
| added during soy sauce- | ∘ | x | ∘ | x |
| like seasoning-preparing | | | | |

The results of component analysis of the soy sauce-like seasonings produced as described above (soy sauce-like seasonings of Examples 3(1) to 3(4), soy sauce-like seasonings of Comparative Examples 3(1) to 3(4)) are shown in Table 7. In the Table, Glu indicates the amount of glutamic acid (% w/v), TN indicates the total nitrogen content (% w/v) and Glu/TN indicates the amount of glutamic acid (% w/v) per 1% of TN.

For component analysis, the total nitrogen was analyzed by the Dumas combustion method, glutamic acid was analyzed by the high-performance liquid chromatography/mass spectrometry method, and pH was analyzed by the glass electrode method.

TABLE 7

test plot No.

| | Comp. Ex. | Ex. | Comp. Ex. | Ex. |
|---|---|---|---|---|
| | 3(1) | 3(1) | 3(2) | 3(2) |
| Glu | 0.76 | 0.95 | 0.81 | 0.96 |
| Glu/TN | 0.30 | 0.46 | 0.31 | 0.46 |
| pH | 5.55 | 5.84 | 5.28 | 5.66 |

test plot No.

| | Comp. Ex. | Ex. | Comp. Ex. | Ex. |
|---|---|---|---|---|
| | 3(3) | 3(3) | 3(4) | 3(4) |
| Glu | 0.93 | 1.02 | 0.97 | 1.03 |
| Glu/TN | 0.36 | 0.42 | 0.36 | 0.42 |
| pH | 5.20 | 5.36 | 5.17 | 5.29 |

From the above evaluation results, it is understood that the soy sauce-like seasonings of Examples 3(1) to 3(4) produced by the method as described herein showed considerably higher amounts of glutamic acid (Glu), which is particularly important as an umami component, and the amount of glutamic acid % w/v per 1% of TN (Glu/TN), as compared with the soy sauce-like seasonings of Comparative Examples 3(1) to 3(4) in which crudely-refined protein was added at the time of soy sauce-like seasoning-preparing. The above evaluation results have revealed that the described method affords such excellent effects with respect to the components of the soy sauce-like seasoning produced.

It was also clarified that a soy sauce-like seasoning with higher pH and superior in mellowness can be produced in the method as described herein by performing maturation at lower temperatures.

### Example 4: Examination of Influence of Concentration of Added Materials

Starting Material

A soy sauce-like seasoning was prepared using the following beans as starting materials and crudely-refined protein or amino acid.

(1) Bean

pea: US #1 YELLOW SPLIT PEAS

(2) Crudely-Refined Protein

pea protein: Pea Protein Isolate EPPI/RADIPURE E8001G

(3) Amino Acid

glutamine

A. Crudely-Refined Protein Addition Group

Koji-Making

Water was added to 40 g of peas and mixed (Control Example 4(A1), Comparative Example 4(A1) to 4(A7), Example 4(A1) to 4(A7)), and the mixture was steamed in an autoclave at 109° C. for 20 min. The mixture was allowed to cool to 40° C. or below, 0.1 wt % of seed koji (“Yoi Tane Koji for soy sauce”; manufactured by Bio′c Co., Ltd.) was mixed with steamed peas (Control Example 4(A1), Comparative Examples 4(A1) to 4(A7)) or steamed peas added and mixed with crudely-refined pea protein (Example 4(A1): addition ratio 10% (total weight ratio of starting material pea weight+crudely-refined pea protein weight; hereinafter the same); Example 4(A2): addition ratio 20%; Example 4(A3): addition ratio 35%; Example 4(A4): addition ratio 50%; Example 4(A5): addition ratio 70%; Example 4(A6): addition ratio 80%; Example 4(A7): addition ratio 95%). This was placed in a container and koji was made in a thermostatic and humidistatic apparatus (temperature 30° C., humidity 95%) for 44 hr. Due care was taken 18 hr later and 24 hr later during koji-making to ensure the conditions were maintained

Soy Sauce-Like Seasoning-Preparing and Maturation

A 23% w/w salt solution was added to a mixture of the obtained koji (derived from Comparative Examples 4(A1) to 4(A7)) and crudely-refined pea protein (Comparative Example 4(A1): addition ratio 10% (total weight ratio of starting material peas+crudely-refined pea protein; hereinafter the same); Comparative Example 4(A2): addition ratio 20%; Comparative Example 4(A3): addition ratio 35%; Comparative Example 4(A4): addition ratio 50%; Comparative Example 4(A5): addition ratio 70%; Comparative Example 4(A6): addition ratio 80%; Comparative Example 4(A7): addition ratio 95%), and the mixture was stirred well to obtain moromi. In addition, the salt solution was added to the koji prepared in Examples 4(A1) to 4(A7) such that the starting material weight, the crudely-refined pea protein weight, and the ratio of the salt solution were the same, and the mixtures were stirred well to give moromi (Examples 4(A1) to 4(A7)). For Control Example 4(A1), a 23% w/v salt solution was added the obtained koji, and the mixtures were stirred well to give moromi.

Each of the 9 groups of moromi prepared above was adjusted such that (1) the water content of the starting material after water absorption, and (2) when protein was added before koji-making, the average water content of the starting material after water absorption and the protein, were each about 47%.

The moromi (moromi of 9 groups prepared above) was stored in a constant temperature equipment at 15° C. for one month. One month after soy sauce-like seasoning-preparing, the moromi was placed on non-woven fabric, squeezed by hand, and heated in a hot water bath at 85° C. for 30 min. Furthermore, after leaving the moromi for 3 days in a constant temperature equipment at 55° C., the moromi was filtered through a filter paper to give pea-fermented soy sauce-like seasonings (those derived from the Control Example 4(A1) are abbreviated as the soy sauce-like seasonings of Control Example 4(A1), those derived from the koji of Examples 4(A1) to 4(A7) are abbreviated as the soy sauce-like seasonings of Examples 4(A1) to 4(A7), and those derived from the koji of Comparative Examples 4(A1) to 4(A4) are abbreviated as the soy sauce-like seasonings of Comparative Examples 4(A1) to 4(A4), respectively).

In Comparative Examples 4(5) to 4(7), soy sauce-like seasonings could not be obtained under the present test conditions, because the amount of water absorption by the starting materials was excessive, thus resulting in spoilage, and even if the amount of water absorption was reduced, the amount of koji at the time of soy sauce-like seasoning-preparing was too small. It was clarified that the desired soy sauce-like seasoning can be obtained in the method as described herein even when the amount of crudely-refined protein is large.

The outline of each soy sauce-like seasoning obtained above is shown below.

A. Crudely-Refined Protein Addition Group

TABLE 8

| | test plot No. | | | | |
|---|---|---|---|---|---|
| | Cont. Ex. | Comp. Ex. | Ex. | Comp. Ex. | Ex. |
| | 4(A1) | 4(A1) | 4(A1) | 4(A2) | 4(A2) |
| crudely-refined | 0% | 10% | 10% | 20% | 20% |
| protein addition | | | | | |
| ratio | | | | | |
| added during | x | x | ∘ | x | ∘ |
| koji-making | | | | | |
| added during soy | x | ∘ | x | ∘ | x |
| sauce-like | | | | | |
| seasoning- | | | | | |
| preparing | | | | | |

| | test plot No. | | | |
|---|---|---|---|---|
| | Comp. Ex. | Ex. | Comp. Ex. | Ex. |
| | 4(A3) | 4(A3) | 4(A4) | 4(A4) |
| crudely-refined protein | 35% | 35% | 50% | 50% |
| addition ratio | | | | |
| added during koji-making | x | ∘ | x | ∘ |
| added during soy sauce- | ∘ | x | ∘ | x |
| like seasoning-preparing | | | | |

| | test plot No. | | | | | |
|---|---|---|---|---|---|---|
| | Comp. Ex. | Ex. | Comp. Ex. | Ex. | Comp. Ex. | Ex. |
| | 4(A5) | 4(A5) | 4(A6) | 4(A6) | 4(A7) | 4(A7) |
| crudely- | 70% | 70% | 80% | 80% | 95% | 95% |
| refined | (soy | | (soy | | (soy | |
| protein | sauce- | | sauce- | | sauce- | |
| addition | like | | like | | like | |
| ratio | seasoning | | seasoning | | seasoning | |
| | was not | | was not | | was not | |
| | prepared) | | prepared) | | prepared) | |
| added during | x | ∘ | x | ∘ | x | ∘ |
| koji-making | | | | | | |
| added during | ∘ | x | ∘ | x | ∘ | x |
| soy sauce-like | | | | | | |
| seasoning- | | | | | | |
| preparing | | | | | | |

B. Amino Acid Addition Group

Koji-Making

Water was added to 40 g of peas and mixed (Control Example 4(B1), Comparative Examples 4(B1) to 4(B4), Examples 4(B1) to 4(B4)), and the mixture was steamed in an autoclave at 109° C. for 20 min. The mixture was allowed to cool to 40° C. or below, 0.1 wt % of seed koji (“Yoi Tane Koji for soy sauce”; manufactured by Bio'c Co., Ltd.) was mixed with steamed peas (Control Example 4(B1), Comparative Examples 4(B1) to 4(B4)) or steamed peas added and mixed with glutamine (Example 4(B1): glutamine addition ratio 2% (starting material pea weight ratio; hereinafter the same); Example 4(B2): glutamine addition ratio 3%; Example 4(B3): glutamine addition ratio 5%; Example 4(B4): glutamine addition ratio 10%). This was placed in a container and koji was made in a thermostatic and humidistatic apparatus (temperature 30° C., humidity 95%) for 44 hr. Due care was taken 18 hr later and 24 hr later during koji-making to ensure the conditions were maintained

Soy Sauce-Like Seasoning-Preparing and Maturation

A 23% w/w salt solution was added to a mixture of the obtained koji (derived from Comparative Example 4(B1) to 4(B4)) and glutamine (Comparative Example 4(B1): glutamine addition ratio 2% (weight ratio of starting material peas; hereinafter the same); Comparative Example 4(B2): glutamine addition ratio 3%; Comparative Example 4(B3): glutamine addition ratio 5%; Comparative Example 4(B4): glutamine addition ratio 10%), and the mixture was stirred well to obtain moromi. In addition, the salt solution was added to the koji prepared in Examples 4(B1) to 4(B4) such that the starting material weight, the crudely-refined pea protein weight, and the ratio of the salt solution were the same, and the mixtures were stirred well to give moromi (Examples 4(B1) to 4(B4)). For Control Example 4(B1), a 23% w/w salt solution was added to the obtained koji, and the mixtures were stirred well to give moromi.

Each of the 9 groups of moromi prepared above was adjusted such that (1) the water content of the starting material after water absorption, and (2) when protein was added before koji-making, the average water content of the starting material after water absorption and the protein, were each about 47%.

The moromi (moromi of 9 groups prepared above) was stored in a constant temperature equipment at 15° C. for one month. One month after soy sauce-like seasoning-preparing, the moromi was placed on non-woven fabric, squeezed by hand, and heated in a hot water bath at 85° C. for 30 min. Furthermore, after leaving the moromi for 3 days in a constant temperature equipment at 55° C., the moromi was filtered through a filter paper to give pea-fermented soy sauce-like seasonings (those derived from the Control Example 4(A1) are abbreviated as the soy sauce-like seasonings of Control Example 4(B1), those derived from the koji of Examples 4(B1) to 4(B4) are abbreviated as the soy sauce-like seasonings of Examples 4(B1) to 4(B4), and those derived from the koji of Comparative Examples 4(B1) to 4(B4) are abbreviated as the soy sauce-like seasonings of Comparative Examples 4(B1) to 4(B4), respectively).

The outline of each soy sauce-like seasoning obtained above is shown below.

B. Amino Acid Addition Group

TABLE 9

| | test plot No. | | | | |
|---|---|---|---|---|---|
| | Cont. | Comp. | | Comp. | |
| | Ex. | Ex. | Ex. | Ex. | Ex. |
| | 4(B1) | 4(B1) | 4(B1) | 4(B2) | 4(B2) |
| amino acid addition rate | 0% | 2% | 2% | 3% | 3% |
| added during koji-making | x | x | ∘ | x | ∘ |
| added during soy sauce- | x | ∘ | x | ∘ | x |
| like seasoning-preparing | | | | | |

| | test plot No. | | | |
|---|---|---|---|---|
| | Comp. Ex. | Ex. | Comp. Ex. | Ex. |
| | 4(B3) | 4(B3) | 4(B4) | 4(B4) |
| amino acid addition rate | 5% | 5% | 10% | 10% |
| added during koji-making | x | ∘ | x | ∘ |
| added during soy sauce- | ∘ | x | ∘ | x |
| like seasoning-preparing | | | | |

The results of component analysis of the soy sauce-like seasonings produced as described above (soy sauce-like seasoning of Control Example 4(A1), soy sauce-like seasonings of Examples 4(A1) to 4(A4), soy sauce-like seasonings of Comparative Examples 4(A1) to 4(A4), soy sauce-like seasoning of Control Example 4(B1), soy sauce-like seasonings of Examples 4(B1) to 4(B4), soy sauce-like seasonings of Comparative Examples 4(B1) to 4(B4)) are shown in Tables 10 and 11 below. In the Tables, Glu indicates the amount of glutamic acid (% w/v), TN indicates the total nitrogen content (% w/v) and Glu/TN indicates the amount of glutamic acid (% w/v) per 1% of TN.

For component analysis, the total nitrogen was analyzed by the Dumas combustion method, and glutamic acid was analyzed by the high-performance liquid chromatography/mass spectrometry method.

A. Crudely-Refined Protein Addition Group

TABLE 10

| | test plot No. | | | | |
|---|---|---|---|---|---|
| | Cont. Ex. | Comp. Ex. | Ex. | Comp. Ex. | Ex. |
| | 4(A1) | 4(A1) | 4(A1) | 4(A2) | 4(A2) |
| Glu | 0.72 | 0.85 | 0.86 | 1.12 | 1.20 |
| Glu/TN | 0.56 | 0.52 | 0.53 | 0.55 | 0.68 |

test plot No.

| | Comp. Ex. | Ex. | Comp. Ex. | Ex. |
|---|---|---|---|---|
| | 4(A3) | 4(A3) | 4(A4) | 4(A4) |
| Glu | 1.03 | 1.50 | 0.99 | 1.53 |
| Glu/TN | 0.45 | 0.70 | 0.43 | 0.76 |

| | test plot No. | | | | | |
|---|---|---|---|---|---|---|
| | Comp. Ex. | Ex. | Comp. Ex. | Ex. | Comp. Ex. | Ex. |
| | 4(A5) | 4(A5) | 4(A6) | 4(A6) | 4(A7) | 4(A7) |
| Glu | — | 1.78 | — | 1.95 | — | 1.97 |
| Glu/TN | — | 0.84 | — | 0.88 | — | 0.84 |

From the above evaluation results, it is understood that the soy sauce-like seasonings of Examples 4(A1) to 4(A4) showed considerably higher amounts of glutamic acid (Glu), which is particularly important as an umami component, and the amount of glutamic acid % w/v per 1% of TN (Glu/TN), as compared with the soy sauce-like seasonings of Control Example 4(A1) in which crudely-refined protein is not added, and the soy sauce-like seasonings of Comparative Examples 4(A1) to 4(A4) in which crudely-refined protein was added at the time of soy sauce-like seasoning-preparing.

The above evaluation results have revealed that the method as described herein affords such excellent effects with respect to the components of the soy sauce-like seasoning produced.

B. Amino Acid Addition Group

TABLE 11

| | test plot No. | | | | |
|---|---|---|---|---|---|
| | Cont. Ex. | Comp. Ex. | Ex. | Comp. Ex. | Ex. |
| | 4(B1) | 4(B1) | 4(B1) | 4(B2) | 4(B2) |
| Glu | 0.64 | 0.92 | 0.77 | 0.97 | 0.88 |
| Glu/TN | 0.56 | 0.62 | 0.54 | 0.64 | 0.70 |

test plot No.

| | Comp. Ex. | Ex. | Comp. Ex. | Ex. |
|---|---|---|---|---|
| | 4(B3) | 4(B3) | 4(B4) | 4(B4) |
| Glu | 1.17 | 1.22 | 1.09 | 2.38 |
| Glu/TN | 0.68 | 0.79 | 0.53 | 1.32 |

From the above evaluation results, it is understood that the soy sauce-like seasonings of Example 4(B3) to 4(B4) showed considerably higher amounts of glutamic acid (Glu), which is particularly important as an umami component, as compared with the soy sauce-like seasonings of Control Example 4(B1) in which crudely-refined protein is not added, and the soy sauce-like seasonings of Comparative Examples 4(B3) to 4(B4) in which crudely-refined protein was added at the time of soy sauce-like seasoning-preparing, and the soy sauce-like seasonings of Example 4(B3) to 4(B4) showed considerably higher amounts of glutamic acid % w/v per 1% of TN (Glu/TN), as compared with the soy sauce-like seasonings of Control Example 4(B1) in which crudely-refined protein is not added, and the soy sauce-like seasonings of Comparative Examples 4(B2) to 4(B4) in which crudely-refined protein was added at the time of soy sauce-like seasoning-preparing. The latter indicates that the addition of amino acid improves the production efficiency of glutamic acid, and the improvement of glutaminase activity due to the addition of amino acid is considered to be one of the reasons therefor.

The above evaluation results have revealed that the method as described herein affords such excellent effects with respect to the components of the soy sauce-like seasoning produced. Regarding the amount of glutamic acid (Glu), such superior effect was clearly confirmed when 5% of amino acid was added to the weight of peas as a starting material. In addition, regarding the amount of glutamic acid % w/v per 1% of TN (Glu/TN), such superior effect was clearly confirmed when 3% of amino acid was added to the weight of peas as a starting material. However, for any of the evaluation items, the effects of lower amounts of amino acid added are not denied.

### Example 5: Examination of Influence of the Kind of Amino Acid Added

Starting Material

A soy sauce-like seasoning was prepared using the following beans as starting materials and amino acid.

(1) Beans

peas: US #1 YELLOW SPLIT PEAS

(2) Amino Acid

alanine, glycine, arginine

(Koji-Making)

Water was added to 40 g of peas and mixed (Comparative Examples 5(1) to 5(3), Examples 5(1) to 5(3)), and the mixture was steamed in an autoclave at 109° C. for 20 min. The mixture was allowed to cool to 40° C. or below, 0.1 wt % of seed koji (“Yoi Tane Koji for soy sauce”; manufactured by Bio′c Co., Ltd.) was mixed with steamed peas (Comparative Examples 5(1) to 5(3)), or steamed peas added and mixed with amino acid (Example 5(1): alanine was added as amino acid, addition ratio: 3% (starting material pea weight ratio; hereinafter the same); Example 5(2): glycine was added as amino acid, addition ratio: 3%; Example 5(3): arginine was added as amino acid, addition ratio: 3%). This was placed in a container and koji was made in a thermostatic and humidistatic apparatus (temperature 30° C., humidity 95%) for 44 hr. Due care was taken 18 hr later and 24 hr later during koji-making to ensure the conditions were maintained.

Soy Sauce-Like Seasoning-Preparing and Maturation

A 23% w/w salt solution was added to a mixture of the obtained koji (derived from Comparative Examples 5(1) to 5(3)) and amino acid (Comparative Example 5(1): alanine was added as amino acid, addition ratio: 3% (starting material pea weight ratio; hereinafter the same); Comparative Example 5(2): glycine was added as amino acid, addition ratio: 3%; Comparative Example 5(3): arginine was added as amino acid, addition ratio: 3%), and the mixture was stirred well to obtain moromi. In addition, the salt solution was added to the koji prepared in Examples 5(1) to 5(3) such that the starting material weight, the amino acid weight, and the ratio of the salt solution were the same, and the mixtures were stirred well to give moromi (Examples 5(1) to 5(3)).

Each of the 6 groups of moromi prepared above was adjusted such that (1) the water content of the starting material after water absorption, and (2) when protein was added before koji-making, the average water content of the starting material after water absorption and the protein, were each about 47%.

The moromi (moromi of 6 groups prepared above) was stored in a constant temperature equipment at 15° C. for one month. One month after soy sauce-like seasoning-preparing, the moromi was placed on non-woven fabric, squeezed by hand, and heated in a hot water bath at 85° C. for 30 min. Furthermore, after leaving the moromi for 3 days in a constant temperature equipment at 55° C., the moromi was filtered through a filter paper to give pea-fermented soy sauce-like seasonings (those derived from the koji of Examples 5(1) to 5(3) are abbreviated as the soy sauce-like seasonings of Examples 5(1) to 5(3), and those derived from the koji of Comparative Examples 5(1) to 5(3) are abbreviated as the soy sauce-like seasonings of Comparative Examples 5(1) to 5(3), respectively).

The outline of each soy sauce-like seasoning obtained above is shown below.

TABLE 12

| | test plot No. | | | | | |
|---|---|---|---|---|---|---|
| | Comp. | | Comp. | | Comp. | |
| | Ex. | Ex. | Ex. | Ex. | Ex. | Ex. |
| | 5(1) | 5(1) | 5(2) | 5(2) | 5(3) | 5(3) |
| amino acid | alanine | alanine | glycine | glycine | arginine | arginine |
| added during | x | ∘ | x | ∘ | x | ∘ |
| koji-making | | | | | | |
| added during | ∘ | x | ∘ | x | ∘ | x |
| soy sauce- | | | | | | |
| like seasoning- | | | | | | |
| preparing | | | | | | |

The results of component analysis of the soy sauce-like seasonings produced as described above (soy sauce-like seasoning of Examples 5(1) to 5(3), and soy sauce-like seasonings of Comparative Examples 5(1) to 5(3)) are shown in Table 13 below. In the Tables, Glu indicates the amount of glutamic acid (% w/v), TN indicates the total nitrogen content (% w/v) and Glu/TN indicates the amount of glutamic acid (% w/v) per 1% of TN.

For component analysis, the total nitrogen was analyzed by the Dumas combustion method, and glutamic acid was analyzed by the high-performance liquid chromatography/mass spectrometry method.

TABLE 13

| | test plot No. | | | | | |
|---|---|---|---|---|---|---|
| | Comp. Ex. | Ex. | Comp. Ex. | Ex. | Comp. Ex. | Ex. |
| | 5(1) | 5(1) | 5(2) | 5(2) | 5(3) | 5(3) |
| Glu | 0.86 | 0.85 | 0.65 | 0.78 | 0.79 | 0.85 |
| Glu/TN | 0.52 | 0.54 | 0.43 | 0.53 | 0.51 | 0.49 |

From the above evaluation results, it is understood that the soy sauce-like seasonings of Examples 5(1) to 5(3) showed considerably higher amounts of glutamic acid (Glu), which is particularly important as an umami component, and/or considerably higher amounts of glutamic acid % w/v per 1% of TN (Glu/TN), as compared with the soy sauce-like seasonings of Comparative Examples 5(1) to 5(3) in which amino acid was added at the time of soy sauce-like seasoning-preparing.

Particularly, such effects were remarkable when glycine was used as the amino acid.

The above evaluation results have revealed that the method as described herein affords such excellent effects with respect to the components of the soy sauce-like seasoning produced.

### Example 6: Examination of Influence of the Kind of Crudely-Refined Protein Added

Starting Material

A soy sauce-like seasoning was prepared using the following beans as starting materials and crudely-refined protein.

(1) Beans

peas: US #1 YELLOW SPLIT PEAS

(2) Crudely-Refined Protein

pea protein: Pea Protein Isolate EPPI/RADIPURE E8001G

soybean protein: New Fujipro SHE

Koji-Making

Water was added to 40 g of peas and mixed (Comparative Examples 6(1) to 6(2), Examples 6(1) to 6(2)), and the mixture was steamed in an autoclave at 109° C. for 20 min. The mixture was allowed to cool to 40° C. or below, 0.1 wt % of seed koji (“Yoi Tane Koji for soy sauce”; manufactured by Bio′c Co., Ltd.) was mixed with steamed peas (Comparative Examples 6(1) to 6(2)) or steamed peas added and mixed with crudely-refined protein (Example 6(1): pea protein was added as crudely-refined protein to achieve starting material pea weight:pea protein weight of 80:20; Example 6(2): soybean protein was added as crudely-refined protein at the same ratio). This was placed in a container in a stainless container and koji was made in a thermostatic and humidistatic apparatus (temperature 30° C., humidity 95%) for 44 hr. Due care was taken 18 hr later and 24 hr later during koji-making to ensure the conditions were maintained.

Soy Sauce-Like Seasoning-Preparing and Maturation

A 23% w/w salt solution was added to a mixture of the obtained koji (derived from Comparative Examples 6(1) to 6(2)) and crudely-refined protein (Comparative Example 6(1): pea protein was added as crudely-refined protein to achieve starting material pea weight:soybean protein weight of 80:20; Comparative Example 6(2): soybean protein was added as crudely-refined protein at the same ratio), and the mixture was stirred well to obtain moromi. In addition, the salt solution was added to the koji prepared in Examples 6(1) to 6(2) such that the starting material weight, the crudely-refined pea protein weight, and the ratio of the salt solution were the same, and the mixtures were stirred well to obtain moromi (Examples 6(1) to 6(2)).

Each of the 4 groups of moromi prepared above was adjusted such that (1) the water content of the starting material after water absorption, and (2) when protein was added before koji-making, the average water content of the starting material after water absorption and the protein, were each about 47%.

The moromi (moromi of 4 groups prepared above) was stored in a constant temperature equipment at 15° C. for one month. One month after soy sauce-like seasoning-preparing, the moromi was placed on non-woven fabric, squeezed by hand, and heated in a hot water bath at 85° C. for 30 min. Furthermore, after leaving same for 3 days in a constant temperature equipment at 55° C., the moromi was filtered through a filter paper to give pea-fermented soy sauce-like seasonings (those derived from the koji of Examples 6(1) to 6(2) are abbreviated as the soy sauce-like seasonings of Examples 6(1) to 6(2), and those derived from the koji of Comparative Examples 6(1) to 6(2) are abbreviated as the soy sauce-like seasonings of Comparative Examples 6(1) to 6(2), respectively).

The outline of each soy sauce-like seasoning obtained above is shown below.

TABLE 14

| | test plot No. | | | |
|---|---|---|---|---|
| | Comp. Ex. | Ex. | Comp. Ex. | Ex. |
| | 6(1) | 6(1) | 6(2) | 6(2) |
| crudely-refined protein | pea | pea | soybean | soybean |
| | protein | protein | protein | protein |
| added during koji-making | x | ∘ | x | ∘ |
| added during soy sauce- | ∘ | x | ∘ | x |
| like seasoning-preparing | | | | |

The results of component analysis of the soy sauce-like seasonings produced as described above (soy sauce-like seasoning of Examples 6(1) to 6(2), and soy sauce-like seasonings of Comparative Examples 6(1) to 6(2)) are shown in Table 15 below. In the Tables, Glu indicates the amount of glutamic acid (% w/v), TN indicates the total nitrogen content (% w/v) and Glu/TN indicates the amount of glutamic acid (% w/v) per 1% of TN.

For component analysis, the total nitrogen was analyzed by the Dumas combustion method, and glutamic acid was analyzed by the high-performance liquid chromatography/mass spectrometry method.

TABLE 15

test plot No.

| | Comp. Ex. | Ex. | Comp. Ex. | Ex. |
|---|---|---|---|---|
| | 6(1) | 6(1) | 6(2) | 6(2) |
| Glu | 1.12 | 1.20 | 0.97 | 1.09 |
| Glu/TN | 0.55 | 0.68 | 0.47 | 0.56 |

From the above evaluation results, it is understood that the soy sauce-like seasonings of Examples 6(1) to 6(2) showed considerably higher amounts of glutamic acid (Glu), which is particularly important as an umami component, and the amount of glutamic acid % w/v per 1% of TN (Glu/TN), as compared with the soy sauce-like seasonings of Comparative Examples 6(1) to 6(2) in which crudely-refined protein was added at the time of soy sauce-like seasoning-preparing.

The above evaluation results have revealed that the method as described herein affords such excellent effects with respect to the components of the soy sauce-like seasoning produced.

The present invention relates to an efficient production method of a new soy sauce-like seasoning with enhanced umami by using pea, broad bean, or chickpea as a main starting material instead of soybean, and is useful in the fields of foods.

1. A method for producing a soy sauce-like seasoning, comprising a koji-making step comprising using, as main starting material(s), one kind of bean or two or more kinds of beans, each selected from pea, broad bean, and chickpea, in the presence of a crudely-refined protein and/or an amino acid.

2. The method according to claim 1, wherein the beans are steamed after mixing with 30 to 200 g of water per 100 g of the total weight of beans, in the koji-making step.

3. The method according to claim 1, wherein the crudely-refined protein is one kind of crudely-refined protein or a mixture of two or more kinds of crudely-refined proteins, each selected from a crudely-refined pea protein, a crudely-refined broad bean protein, a crudely-refined chickpea protein, and a crudely-refined soybean protein.

4. The method according to claim 1, wherein the beans and the crudely-refined protein are mixed at a ratio of 99.5:0.5 to 0.5:99.5 (w/w).

5. The method according to claim 1, wherein the amino acid is one amino acid or a mixture of two or more amino acids, each selected from glutamine, arginine, glycine, and alanine.

6. The method according to claim 1, wherein the amino acid is mixed with the beans at a ratio of 3% to 15% (weight ratio of amino acid with respect to beans) in the koji-making step.

7. The method according to claim 1, further comprising a step of mixing the koji obtained by the koji-making step with a salt (sodium chloride) solution to produce “moromi”, and maturing the moromi within a temperature range of 5 to 50° C.

8. The method according to claim 1, wherein a seed koji derived from rice is used as a seed koji in the koji-making step.

9. The method according to claim 7, wherein the moromi is matured for 2 weeks to 6 months.

10. The method according to claim 9, wherein the moromi is matured in a temperature range of 10 to 45° C.
